(19) United States
(12) Patent Application Publication
(10) Pub. No.: US 2026/0267299 A1
(43) Pub. Date: Sep. 10, 2026

(54) METHODS, APPARATUSES, AND COMPUTER-READABLE STORAGE MEDIA FOR GUIDED DIFFUSION POLICY-BASED MACHINE CONTROL

(71) Applicant: HUAWEI TECHNOLOGIES CO., LTD., Shenzhen (CN)

(72) Inventors: Rui Heng Yang, Kanata (CA); Amir Rasouli, Kanata (CA); Yinchuan Li, Shenzhen (CN)

(21) Appl. No.: 19/071,284

(22) Filed: Mar. 5, 2025

(51) Int. Cl. G05B 13/02

(52) U.S. Cl. CPC G05B 13/0275

(57) ABSTRACT

A method for guided diffusion policy-based machine control comprises initializing an action queue and repeating a set of steps to iteratively generating a sequence of denoised machine control actions using a diffusion model having H sampling steps. The action queue comprises a sequence of H actions for controlling a machine, wherein H is an integer, and the sequence of actions have monotonically increasing noise. The repeated set of steps comprises: performing a denoising step on the action queue using the diffusion model, thereby generating a denoised machine control action at a front of the action queue; outputting the denoised machine control action; generating a guidance signal as a function of guidance data; applying the guidance signal to the action queue; and updating the action queue, comprising removing the denoised machine control action from the front of the action queue.

### TECHNICAL FIELD

The present application is related to machine control using machine learning models. More particularly, the present application relates to machine control using a guided diffusion policy.

### BACKGROUND

Embodied Artificial Intelligence (EAI) has emerged as a rapidly advancing field, gaining significant attention in both industry and academia. EAI may include automated machine control, in which an AI-based policy generates a series of “actions” for controlling a machine, such as a robot. Safety is paramount in commercializing any EAI agent. In machine control, collision avoidance is important for providing safe, seamless interactions, especially in human-centered environments. It is also desirable to implement real-time processing speed to enable the machine to respond quickly and effectively within dynamic environments, thereby reducing risks and enhancing overall reliability.

Diffusion models have gained attention for their impressive performance in tasks, such as image generation, video synthesis, and text-to-image conversion. Diffusion policies (i.e., diffusion-based models for machine control) have more recently been employed for learning and improving machine control tasks, such as robotics control. See, for example: Chi et al., “Diffusion Policy: Visuomotor Policy Learning via Action Diffusion,” Mar. 14, 2024, arXiv: arXiv:2303.04137. doi: 10.48550/arXiv.2303.04137; and Ze et al., “3D Diffusion Policy: Generalizable Visuomotor Policy Learning via Simple 3D Representations,” Jun. 8, 2024, arXiv: arXiv:2403.03954 (available at <http://arxiv.org/abs/2403.03954>), the entire contents of which are incorporated herein by reference. Diffusion-based models for machine control may be expressive enough to handle complex manipulation tasks and be trained stably while adapting to high-dimensional action spaces. These features make diffusion models well-suited for addressing many challenges in machine control.

Diffusion policies may use guidance signals, such as maximizing rewards or satisfying constraints, to guide or influence the denoising process. The “guidance signal” comprises input provided to the diffusion model to steer the generative, sequential denoising process. Prior diffusion policy technologies have used classifier-guided or classifier-free guidance methods. However, these methods struggle to generalize to unseen conditions during inference and are unable to represent some guidance signals as conditional variables for training. Classifier guidance leverages a pre-trained classifier to influence the denoising process through its gradient. However, this method faces challenges in generalization, as it requires training a new classifier and retraining the diffusion model whenever the guidance conditions change. In classifier-free guidance, the guidance signal is incorporated directly into the diffusion model during training. While this method eliminates the need for a separate classifier, it similarly struggles with generalization because the model must be retrained whenever new information is introduced. Both classifier-guided and classifier-free guidance methods, therefore, share a significant limitation: they cannot generalize to unseen conditions during inference, restricting their applicability in dynamic or complex environments. Another challenge for diffusion policy models adapting to dynamic environments is the runtime inefficiency of prior approaches, which prevents effective high-frequency closed-loop replanning. The denoising diffusion process is computationally intensive, with inference rates of some prior methods being below 20 Hz. This limitation hinders the ability of the policy to perform closed-loop control-a critical requirement for effective robot manipulation. This problem occurs because, in prior approaches, the diffusion model must generate an entire action sequence before executing a subset of them and replanning, which is time-consuming. For example, the diffusion policy may predict 16 actions before executing eight of those actions and replanning. Increasing replanning frequency by shortening prediction and action horizons is possible but may significantly impact the performance. Denoising diffusion implicit models (DDIMs) are described by Song, et al., “Denoising Diffusion Implicit Models,” arXiv: arXiv:2010.02502, Oct. 5, 2022 (available at <http://arxiv.org/abs/2010.02502>, the entire contents of which are incorporated herein by reference. DDIMs may reduce the sampling steps at inference. However, the time required to predict the sequence of actions may be slower than typical low-level robotic control systems, creating a bottleneck for the system.

### SUMMARY

According to an aspect of the disclosure, there is provided a method for guided diffusion policy-based machine control, the method comprising: initializing an action queue, the action queue comprising a sequence of H actions for controlling a machine, wherein ‘H’ is an integer, the sequence of actions having monotonically increasing noise; and repeating a set of steps to iteratively generate a sequence of denoised machine control actions using a diffusion model having H sampling steps, the set of steps comprising, for each iteration: performing a respective denoising step on the action queue using the diffusion model, thereby generating a respective denoised machine control action at a front of the action queue; outputting the respective denoised machine control action for controlling the machine; generating a respective guidance signal as a function of guidance data; and applying the respective guidance signal to the action queue; and updating the action queue, comprising removing the respective denoised machine control action from the front of the action queue.

In some embodiments, updating the action queue further comprises appending a new noisy machine control action to an end of the action queue.

In some embodiments, performing the denoising step comprises performing a single diffusion sampling step on the action queue by the diffusion model.

In some embodiments, performing the denoising step comprises performing the denoising step as a function of machine state data.

In some embodiments, the method further comprises, after outputting the respective denoised machine control action, obtaining updated machine state data.

In some embodiments, the guidance data comprises one or both of environment observation data and constraint data.

In some embodiments, the method further comprises, after outputting the respective denoised machine control action, obtaining updated environment observation data.

In some embodiments, the guidance signal is a training free guidance signal.

In some embodiments, the guidance signal is generated using a differentiable loss function method.

In some embodiments, the machine comprises a robot.

According to another aspect of the disclosure, there is provided an apparatus comprising: at least one processor; and one or more non-transitory computer-readable storage media functionally coupled to the at least one processor; wherein the one or more non-transitory computer-readable storage media comprise computer-executable instructions, wherein the instructions, when executed, cause the at least one processor to perform a method for guided diffusion policy-based machine control, the method comprising: initializing an action queue, the action queue comprising a sequence of ‘H’ actions for controlling a machine, wherein ‘H’ is an integer, the sequence of actions having monotonically increasing noise; repeating a set of steps to iteratively generate a sequence of denoised machine control actions using a diffusion model having ‘H’ sampling steps, the set of steps comprising, for each iteration: performing a respective denoising step on the action queue using the diffusion model, thereby generating a respective denoised machine control action at a front of the action queue; outputting the respective denoised machine control action for controlling the machine; generating a respective guidance signal as a function of guidance data; and applying the respective guidance signal to the action queue; and updating the action queue, comprising removing the respective denoised machine control action from the front of the action queue.

In some embodiments, updating the action queue further comprises appending a new noisy machine control action to an end of the action queue.

In some embodiments, performing the denoising step comprises performing a single diffusion sampling step on the action queue by the diffusion model.

In some embodiments, performing the denoising step comprises performing the denoising step as a function of machine state data.

In some embodiments, the method further comprises, after outputting the respective denoised machine control action, obtaining updated machine state data.

In some embodiments, the guidance data comprises one or both of environment observation data and constraint data.

In some embodiments, the method further comprises, after outputting the respective denoised machine control action, obtaining updated environment observation data.

In some embodiments, the guidance signal is a training free guidance signal.

In some embodiments, the guidance signal is generated using a differentiable loss function method.

According to another aspect of the disclosure, there is provided or more non-transitory computer-readable storage media comprising computer-executable instructions, wherein the instructions, when executed, cause at least one processor to perform the method(s) as described herein.

According to one aspect of this disclosure, there is provided one or more non-transitory, computer-readable storage media comprising computer-executable instructions; wherein the instructions, when executed, cause the one or more processors to perform any of the above-described methods and/or any of the methods disclosed herein.

According to one aspect of this disclosure, there is provided one or more circuits such as one or more processors for performing the above-described methods.

According to one aspect of this disclosure, there is provided one or more processors functionally connected to one or more memories for performing the above-described methods.

According to one aspect of this disclosure, there is provided an apparatus comprising: one or more processors functionally connected to one or more memories for performing the above-described methods.

According to one aspect of this disclosure, there is provided an apparatus, and configured to perform any of the above-mentioned methods and their embodiments. Specifically, the apparatus includes one or more units configured to perform any of the above-mentioned methods and their embodiments.

According to one aspect of this disclosure, there is provided a computer-readable storage medium. The computer-readable storage medium stores a computer program, and when the computer program is executed by an apparatus, the apparatus is enabled to implement any of the above-mentioned methods and their embodiments.

According to one aspect of this disclosure, there is provided a computer program product including one or more instructions. When the instructions are executed by an apparatus such as a computer, the apparatus is enabled to implement any of the above-mentioned methods and their embodiments.

According to one aspect of this disclosure, there is provided a computer program. When the computer program is executed by a computer, an apparatus is enabled to implement any of the above-mentioned methods and their embodiments.

According to one aspect of this disclosure, there is provided an apparatus for implementing the methods in any possible implementation of the foregoing aspects.

Other aspects and features of the present disclosure will become apparent to those ordinarily skilled in the art, upon review of the following description of the specific embodiments of the disclosure.

### BRIEF DESCRIPTION OF THE DRAWINGS

FIG. 1 is a functional block diagram illustrating an example diffusion policy machine control architecture for closed-loop control of a machine according to some embodiments;

FIG. 2 is a functional block diagram of a diffusion policy of the architecture of FIG. 1, according to some embodiments;

FIG. 3 is a flowchart of an example method for guided diffusion policy machine control according to some embodiments;

FIG. 4 is a functional block diagram of an apparatus that may perform the methods as described herein, according to some embodiments;

FIG. 5 shows simulation results in a three-dimensional space demonstrating a comparison of dynamic obstacle avoidance approaches;

FIG. 6 is a block diagram illustrating input to an LLM to generate guidance information; and

FIG. 7 is a diagram illustrating closed-loop feedback control of a robot according to some embodiments.

### DETAILED DESCRIPTION

The term “machine control” used herein refers to generation and/or execution of “actions” for controlling a machine such as a robotic device. Each action may, for example, comprise directions to actuate one or more components of the machine or perform another machine function. The actions may be communicated to the machine via electronic means such as control signaling. A diffusion model is a type of generative machine learning neural network trained to model the data distribution through sequential denoising steps, a diffusion process. The term “policy” in the context of robotics control refers generally to how observations or other inputs are mapped to actions. For a “diffusion policy,” a diffusion model (a type of generative machine learning model) is used to generate actions for control of a robot or other machine. See also Chi et al. and Ze et al. referred to above. The term “robot” as used herein may broadly refer to a machine that is automatically or semi-automatically controllable by a computer system. However, the disclosure is not limited to control of machines that may typically be considered “robots”. For example, the diffusion policy methods and apparatus described herein may be used for control of vehicles or other types of machines. The methods and principles described herein are not limited to any particular machine, and they may applied in any machine motion planning pipeline such as navigation or embodied artificial intelligence (EAI) tasks.

As discussed above, prior methods for machine control using diffusion policies have suffered from low inference speed due to the time-consuming denoising diffusion process. Previous methods have also had low generalizability to unseen guidance signals.

According to aspects of the present disclosure, a diffusion policy may generate actions at each denoising step, which may significantly increase closed-loop control frequency without compromising performance. The diffusion policy methods described herein may integrate training-free loss-based guidance, which may allow the model to generalize to universal guidance signals during inference without additional training. The term “universal guidance” refers to guidance with arbitrary modalities, such as arbitrary human preferences, constraints, etc. In other words, the guidance is not limited to particular modalities (preferences, constraints, etc.) for which the system was pre-trained. Some training-free loss-based guidance methods are discussed in Shen et al., “Understanding and Improving Training-free Loss-based Diffusion Guidance,” May 29, 2024, arXiv: arXiv:2403.12404. doi: 10.48550/arXiv.2403.12404, the entire contents of which are incorporated herein by reference. The guided diffusion policy may generalize to any conditional information and receive universal guidance signals during inference. The guidance (e.g. preference) may be encoded as a scalar differentiable loss function. The guided diffusion policy described herein, and the associated methods, apparatuses and systems, may be more flexible and responsive than prior solutions.

The universal guidance signals may be generated, at least in part, from large language models and/or any predefined rules or other constraints. The universal guidance signals may adapt a pretrained diffusion model for interaction in unseen environmental conditions without additional training. Aspects and embodiments described herein may enable high-frequency, closed-loop control and allow for real-time action generation and execution. Additionally, by incorporating dynamic environment feedback as universal guidance, aspects of the disclosure may enhance the adaptability of pretrained diffusion policies to rapidly changing conditions.

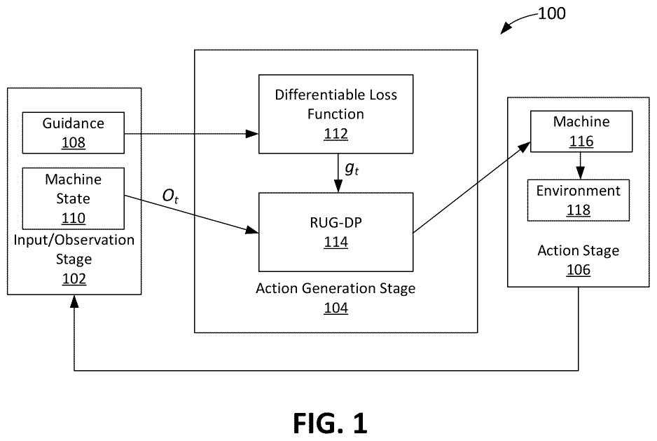

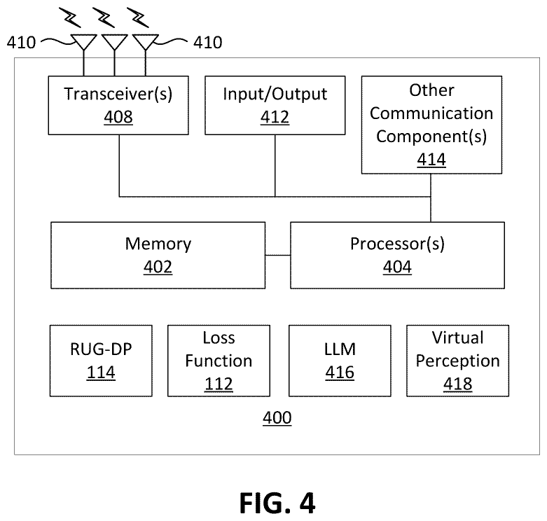

FIG. 1 is a functional block diagram illustrating an example diffusion policy machine control architecture 100 for closed-loop control of a machine 116 according to some embodiments. In general, the diffusion policy machine control architecture 100 includes an Input/Observation stage 102, an action generation stage 104, and an action stage 106. The action generation stage 104 iteratively generates a sequence of actions for controlling the machine 116 based on inputs of the Input/Observation stage 102. Each machine control action may comprise instructions for actuating one or more actuatable components of the machine 116 in particular manner. The “action stage” 106 shown in FIG. 1 includes the machine 116 and the environment 118 in which the machine 116 operates. The functions of the action generation stage 104 and the Input/Observation stage 102 may be implemented by the apparatus 400 of FIG. 4, for example, which is described below.

Referring to FIG. 1, the Input/Observation stage 102 includes input data that may be input to the action generation stage 104. This input data may include guidance data 108 and machine state data 110. The guidance data 108 may include, for example, environment observation data, and constraint data including defined constraints and/or preferences. The machine state data 110 and environment observation data may be referred to herein as “observation data”. The environment observation data may include observations of the environment obtained by one or more sensors, such as Red-Green-Blue (RBG)-Depth (RGBD) images obtained by an RGBD camera. The environment observation data may, for example, comprise state-based, image-based, or point cloud-based data. Images captured by RGB-D cameras may be converted to 3D point cloud data. The constraints may comprise predefined or user-defined rules or preferences for example. The guidance data 108 may, for example, be generated using a Large Language Model (LLM) that receives user input and/or environment observation data as input, and then generates the guidance data 108 as a function of the user input. The machine state data 110 may include data about the current state of the machine including (but not limited to) the position, orientation, and/or pose of machine components such as arms, end-effectors, and more. The guidance data 108 is utilized at inference time to generate guidance signals (discussed below), while the machine state data 110 serves as a condition for generating the next action.

The action generation stage 104 in this example includes a differentiable loss function 112 and a Real-Time Universally Guided Diffusion Policy (RUG-DP) 114. The differentiable loss function 112 receives the guidance data 108 as input and generates, as output, a guidance signal (gₜ) as a function of the loss function and the guidance data 108. The differentiable loss function 112 in this embodiment is a training free module, and the guidance signal (gₜ) is a training-free loss-based guidance signal (gₜ). The term “training free” means that generation and application of the guidance signal does not require re-training the diffusion model or a classifier based on modalities of the guidance data, in contrast to prior classifier-guided or classifier-free guidance methods discussed above.

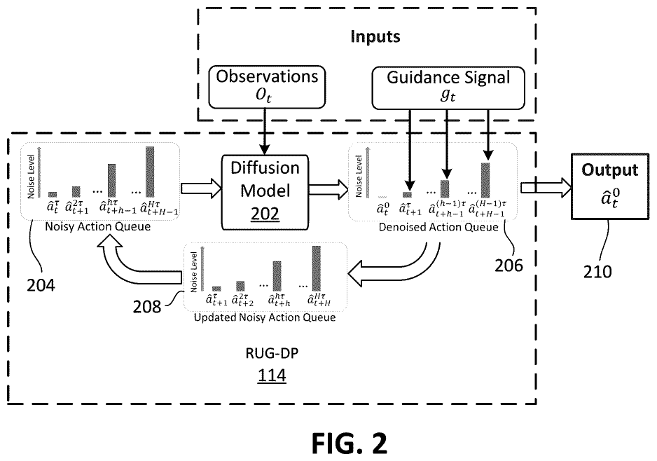

The RUG-DP 114 receives, as input, the guidance signal (gₜ), from the differentiable loss function 112, and the machine state data 110 as input. The machine state data 110 may be referred to as machine observation data (Oₜ). Using a diffusion model and action queue, which will be discussed in more detail below, the RUG-DP 114 iteratively generates, as output, a machine control action for each cycle or inference of the RUG-DP 114. Additional details of the RUG-DP and guidance signal application will be described below with reference to FIG. 2.

The “action stage” 106 includes the machine 116 being controlled, and the environment 118 in which the machine is operating. For each iteration or cycle of the algorithm, the machine 116 is controlled by the machine control action output from the RUG-DP 114, and the environment is updated. The environment may change as an effect of the machine action and/or other dynamic objects and forces in the environment. The new machine state data and environment observation data are fed back to the Input/Observations stage 102 for the next iteration.

FIG. 2 is a functional block diagram of the RUG-DP 114 of FIG. 1. As noted above, the RUG-DP 114 generates a sequence of machine control actions. The RUG-DP 114 includes a diffusion model 202. In this example, the diffusion model 202 is a Denoising Diffusion Implicit Model (DDIM) with “H” sampling steps. The diffusion model 202 may also be referred to as a “denoiser”. A noisy action queue is processed by the denoiser to generate the machine control actions. The noisy action queue comprises a series of noisy machine control actions having monotonically increasing noise, typically Gaussian noise. The term “monotonically increasing noise” means that the noise of the actions in the queue increases by the same incremental amount for each successive action of the queue. The noisy action queue may be represented as:

$${A}_{t}^{k} = \{ {\hat{a}}_{t}^{τ} , {\hat{a}}_{t + 1}^{2 τ} , … {\hat{a}}_{t + h - 1}^{h τ} , … {\hat{a}}_{t + H - 1}^{H τ} \}$$

where

$${A}_{t}^{k}$$

is the noisy action queue 204, H is an integer number of samples of the diffusion model 202, t is time, h is an intermediate sample number in which h=[1, 2, . . . , H], and k is the monotonically increasing noise level in which k=[τ, 2τ, . . . Hτ], and ‘τ’ is a noise gap between two adjacent reverse diffusion steps in which:

$$τ = \frac{K}{H}$$

where K is the maximum Gaussian noise level (H*τ).

To generate a clean action output, the diffusion model 202 may perform a denoising step on the noisy action queue 204, thereby generating a denoised action queue 206, which may be represented as:

$${A}_{t}^{k - 1} = \{ {\hat{a}}_{t}^{0} , {\hat{a}}_{t + 1}^{τ} , … {\hat{a}}_{t + h - 1}^{( h - 1 ) τ} , … {\hat{a}}_{t + H - 1}^{( H - 1 ) τ} \} .$$

The denoising step may comprise a single iteration of the reverse process of the diffusion model, where the diffusion model removes a small amount of noise from the noisy action queue 204. The denoised action

$$( {\hat{a}}_{t}^{0} )$$

at the front of the noisy action queue may be referred to herein as a “clean” action. This “clean” or denoised action

$$( {\hat{a}}_{t}^{0} )$$

is output by the RUG-DP 114 (represented by output 210 in FIG. 2). The denoised action

$$( {\hat{a}}_{t}^{0} )$$

is “denoised” in the sense that it has been completed H denoising sampling steps by the diffusion model. The term “denoised” refers to the diffusion model process that generated the denoised action

$$( {\hat{a}}_{t}^{0} )$$

as opposed to any particular machine control action represented by the denoised action

$$( {\hat{a}}_{t}^{0} ) .$$

After performing the denoising step (i.e. at inference time), the guidance signal (gₜ) generated by the differentiable loss function 112 in FIG. 1 is applied to the denoised action queue 206.

The denoised action queue 206 is updated to remove the clean action

$${\hat{a}}_{t}^{0}$$

and to append a new most-noisy action

$${\hat{a}}_{t + H}^{H τ}$$

at the end of the action queue 206, thereby generating an updated action queue 208 shown in FIG. 2. The updated action queue 208 may be represented as:

$${A}_{t + 1}^{k} = \{ {\hat{a}}_{t + 1}^{τ} , {\hat{a}}_{t + 2}^{2 τ} , … {\hat{a}}_{t + h}^{h τ} , … {\hat{a}}_{t + H}^{H τ} \} .$$

The updated action queue 208 is fed back to the diffusion model 202 as the new noisy action queue 204 (represented by

$${A}_{t}^{k}$$

above) for the next iteration of the cycle. The next iteration of the process will generate a next clean action. This process is repeated to thereby generate a sequence of machine control actions for controlling the machine 116 (shown in FIG. 1). Updating the action queue may occur before the guidance signal is generated and/or applied in other embodiments.

An example of the action generation algorithm described above is shown below in Table 1.

TABLE 1
Algorithm 1: Universally guided closed-loop inference

Input Observations O₀
$Initialize k = [ τ , 2 τ , … H τ ] , τ = \frac{K}{H} , step size η$
$Initialize Action queue : {A}_{0}^{k} = [ {\hat{a}}_{0}^{τ} , {\hat{a}}_{1}^{2 τ} , … , … {\hat{a}}_{H - 1}^{H τ} ]$
Initialize Diffusion Network: x_{θ}
Define Differentiable guidance loss function f
1. for t = 0, 1, ... , T do
$2. Inference diffusion U - NET : {Â}_{t}^{0} = {x}_{θ} ( {A}_{t}^{k} , k , {O}_{t} )$
$3. {A}_{t}^{k - 1} = DDIM ( {Â}_{t}^{0} )$
$4. {g}_{t} = {∇}_{{A}_{t}^{k}} f ( {A}_{t}^{0} , 𝒢 )$
$5. {A}_{t}^{k - 1} = {A}_{t}^{k - 1} - η \cdot \frac{gt}{{‖ gt ‖}_{2}^{2}}$
$6. Execute action {\hat{a}}_{t}^{0} , receive new observation {O}_{t + 1}$
$7. Update action queue : {A}_{t + 1}^{k} = [ {\hat{a}}_{t + 1}^{τ} , , … {\hat{a}}_{t + H}^{H τ} ]$
8. end for

In table 1, U-Net is an architecture that is used in the diffusion model; K is the maximum noise level (K=H*τ); [symbol] is the conditional variable/information; η is a scalar value to control the effect of the guidance signal; and T is current step in the planning. A guided sample process aims to sample A^{k} conditioned on [symbol] . The equation for gₜ in Table 1 above is an approximation of the training free guidance gradient. Training-free loss-based diffusion guidance is discussed in Shen et al. “Understanding and Improving Training-free Loss-based Diffusion Guidance” May 29, 2024, arXiv: arXiv:2403.12404. doi: 10.48550/arXiv.2403.12404, the entire contents of which are incorporated by reference. See also Song et al, “Loss-Guided Diffusion Models for Plug-and-Play Controllable Generation”, Proceedings of the 40th International Conference on Machine Learning, PMLR 202:32483-32498, 2023, the entire contents of which are incorporated herein by reference.

The effect of the guidance signal (gₜ) on actions in the action queue scales with the amount of noise of each action. Thus, the monotonically increasing Gaussian noise of the actions in the action queue results in the guidance signal (gₜ) having a correspondingly scaled effect on the actions of the action queue, with the least noisy action at the front of the queue being the least affected by the guidance signal (gₜ), and the most noisy action at the end of the queue being the most affected.

This control architecture 100 described herein avoids the need to retrain the model or a classifier to account for changes in guidance modalities, and the RUG-DP 114 may increase the inference speed for generating denoised actions, thereby improving machine control performance. For example, the RUG-DP approach may have an inference speed that is approximately 10 times faster than previous state-of-the-art diffusion-based methods. The RUG-DP may integrate training-free loss-based guidance to produce guided denoised actions without additional training, in a variety of dynamic environments. The guided denoised actions may potentially effectively perform automated machine control tasks such as object collision avoidance in either static or dynamic simulated or real-world environments.

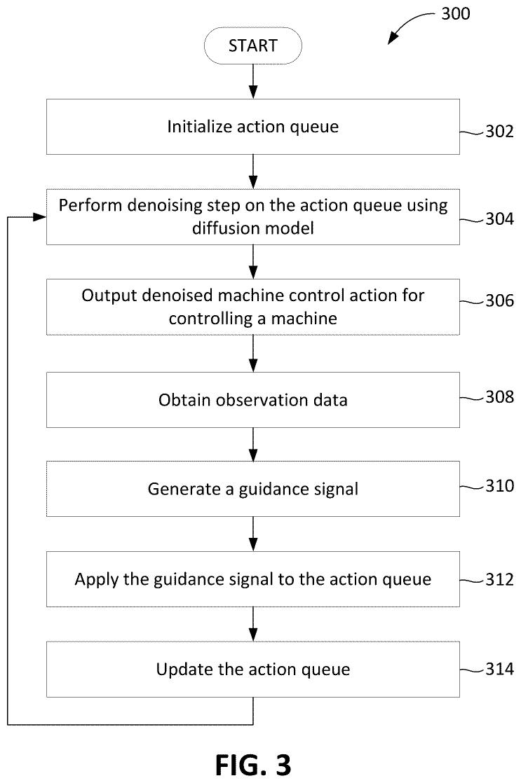

FIG. 3 is a flowchart of an example method 300 for guided diffusion policy machine control according to some embodiments. The method will be described with reference to the RUG-DP 114 of FIGS. 1 and 2.

At block 302, the noisy action queue 204 is initialized. Initializing the action queue may include performing a normal diffusion sampling of a pure noisy action by the diffusion model 202, thereby generating a series of intermediate latent actions. The “pure noisy action” may be any initial arbitrary action that will be “denoised” by the reverse process of the diffusion model. For example, the “pure noisy action” may be randomly generated or pre-determined. The term “noisy action” refers to how the action is treated and processed by the trained diffusion model and does not require Gaussian noise (or other noise) to be applied to the initial pure noisy action. Optionally, initial observed machine state data (Oₒ) may input to the diffusion model for performing the diffusion sampling of the pure noisy action. The intermediate latent actions may be stored. The RUG-DP's novel noisy action queue may be initiated using the stored intermediate latent actions. The resulting initialized action queue has monotonically increasing noise.

At block 304, a denoising step is performed on the action queue using the diffusion model 202, thereby generating a denoised (or “clean”) machine control action at a front of the action queue. Performing the denoising step may comprise performing a single diffusion sampling step on the action queue by the diffusion model 202. Because only one denoising step is performed at this stage, while the remaining H−1 denoising steps were completed beforehand, the clean action may be generated in real-time without compromising performance. Performing the denoising step may comprise inputting current machine state data 110 (Oₜ) to the diffusion model and performing the diffusion sampling step as a function of the current machine state data.

At block 306, the denoised machine control action is output by the RUG-DP 114 for controlling the machine 116. The machine control action output by the RUG-DP 114 may be executed by the machine 116. Optionally, the method further comprises executing the machine control action by the machine 116.

The input data, including environment observation data and machine state data 110, may be updated as a consequence of the machine's movement and/or other dynamic factors in the environment. In this example, at block 308, the method comprises obtaining the updated guidance data 108 and/or updated machine state data 110. Obtaining the updated guidance data 108 may comprise receiving the updated environment observation data from one or more other computerized devices (e.g., the machine 116) using one or more communication components, and/or obtaining the updated environment observation data using one or more sensors, to name a couple examples. Updated machine state data 110 may likewise be received from the machine 116, obtained one or more sensors, and/or obtained in any other suitable manner.

At block 310, a guidance signal (gₜ) is generated as a function of the guidance data 108. As described above, the guidance data 108 used to generate the guidance signal (gₜ) may comprise environment observation data and constraint data. Constraint data may include data defining any constraint or preference for the control of the machine. For example, the constraint data may include preferences or rules. The preferences or rules may be input by a user, received from another computer system, pre-defined and stored in memory, or any combination of the foregoing to name a few examples. The guidance signal (gₜ) may be generated by a differentiable loss function method. That is, the environment observation data and constraint data may be processed by a differentiable loss function to generate the guidance signal (gₜ).

At block 312, the guidance signal (gₜ) is applied to the denoised action queue. The guidance signal (gₜ) may be seamlessly integrated into the action queue, enabling the diffusion model 202 to generalize to universal guidance signals during inference without requiring additional training. Applying the denoised action queue, in some embodiments, may include normalizing the guidance signal and controlling the strength of the guidance signal by applying a scalar value (η), as described by the following formula:

$${A}_{t}^{k - 1} = {A}_{t}^{k - 1} - η \cdot \frac{gt}{{‖ gt ‖}_{2}^{2}}$$

At block 314 the action queue is updated by removing the respective denoised machine control action from the front of the action queue. Updating the action queue may further comprise appending a new noisy action at the end of the queue. Similar to the initial noisy action used to initialize the action queue at block 302, the new noisy action may be any action (e.g. randomly generated) that is appended to the end of the action queue. Updating the action queue may occur before generating and/or applying the guidance signal at blocks 310 and 312.

The method 300 further comprises repeating steps of blocks 304 to 314 to iteratively generate a sequence of denoised machine control actions. In other embodiments, one or more steps of the method 300 may be performed in a different order, more steps may be added, and/or one or more steps may be omitted or varied.

FIG. 4 is a functional block diagram of an apparatus 400 that may perform the methods described herein, such as the method 300 of FIG. 3, according to some embodiments. The apparatus 400 may be a controller of a machine, for example. The apparatus 400 comprises memory 402 and at least one processor 404 functionally connected to the memory 402. The memory 402 may be any form of non-transitory, computer-readable storage media. The memory 402 contains computer-executable instructions that, when executed, cause the at least one processor 404 to implement the methods described above with reference to FIG. 3 or otherwise described herein. More specifically the computer-executable instructions cause the at least one processor to implement the guided diffusion policy functions described above with reference to FIGS. 1 to 3. More specifically, in this example, the at least one processor 404 to implement RUG-DP 114 and differentiable loss function 112.

In some embodiments, the apparatus 400 may further comprise at least one transmitter and at least one receiver (collectively represented in FIG. 4 as at least one transceiver 408), at least one antenna 410 or network interface controller (NIC), one or more input/output components 412, and/or at least one other communication component 414. Each of these components 402 to 414 may be implemented as one or more circuits (such as one or more electronic circuits and/or one or more optical circuits). Alternatively, the ensemble of these components 402 to 414 may be implemented as one or more circuits. In various embodiments, the apparatus 400 may also comprise other components as needed or as desired.

Constraints such as user-defined preferences and/or LLM input may also be received via the at least one transceiver 408, the at least one other communication component 414, and/or the one or more input/output components 412. In some embodiments, the apparatus 400 may also include an LLM 416 implemented by the memory 402 and at least one processor 404 (or other software and/or hardware components) for generating constraint data from user input to the LLM. The apparatus 400 may also include a visual perception module 418 implemented by the memory 402 and at least one processor 404 (or other software and/or hardware components). The visual perception module may perform object segmentation on 3D point cloud observation data. The visual perception module may output environment observation data used in generation of the guidance signal (gₜ).

One or more components described above, such as the at least one transceiver 408, antennas 410, one or more input/output components 412, at least one other communication component 414, the LLM, and/or the visual perception module 418, may be omitted in other embodiments.

The at least one processor 404 may be configured for performing various processing operations such as signal coding, data processing, power control, input/output processing, or any other functionalities to enable the apparatus to implement the diffusion policy methods described herein. The at least one processor 404 may comprise a central processing unit (CPU), a microprocessor, a microcontroller, a digital signal processor, an accelerator, a graphic processing unit (GPU), a tensor processing unit (TPU), a FPGA, or an ASIC. Examples of the processor(s) 404 may be an ARM® microprocessor (ARM is a registered trademark of Arm Ltd., Cambridge, UK) manufactured by a variety of manufactures such as Qualcomm of San Diego, California, USA, under the ARM® architecture, an INTEL® microprocessor (INTEL is a registered trademark of Intel Corp., Santa Clara, CA, USA), an AMD® microprocessor (AMD is a registered trademark of Advanced Micro Devices Inc., Sunnyvale, CA, USA), and the like. In some embodiments, the at least one processor 404 may execute computer-executable instructions or code stored in the memory 402 to perform various processes described below. The memory 402 and at least one processor 404 may also be implemented a variety of software and/or hardware combinations.

The at least one transceiver 408 may be configured for modulating data or other content for transmission by the at least one antenna 410 to communicate other devices over a communication network. The transceiver 408 is also configured for demodulating data or other content received by the at least one antenna 410. Each transceiver 408 may comprise any suitable structure for generating signals for wireless transmission and/or processing signals received wirelessly. Each antenna 410 may comprise any suitable structure for transmitting and/or receiving wireless signals. Although shown as a single functional unit, a transceiver 408 may be implemented separately as at least one transmitter and at least one receiver.

The one or more input/output components 412 are configured for interaction with a user or other devices. Each input/output component 412 may comprise any suitable structure for providing information to or receiving information from a user and may be, for example, a speaker, a microphone, a keypad, a keyboard, a display, a touch screen, and/or the like.

The memory 402 is configured for storing instructions executable by at least one processor 404 and data used, generated, or collected by the at least one processor 404. For example, the memory 402 may store instructions of software, software systems, or software modules that are executable by the at least one processor 404 for implementing some or all of the functionalities and/or embodiments of the diffusion policy methods described herein. The memory 402 may comprise any suitable volatile and/or non-volatile storage and retrieval components such as RAM, ROM, hard disk, optical disc, SIM card, solid-state memory modules, memory stick, SD memory card, and/or the like.

The at least one other communication component 414 may be configured for communicating with other devices (e.g. machines) via other communication means such as a radio link, a BLUETOOTH® link (BLUETOOTH is a registered trademark of Bluetooth Sig Inc., Kirkland, WA, USA), a wired sidelink, and/or the like. Examples of the wired sidelink may be a USB cable, a network cable, a parallel cable, a serial cable, and/or the like. The other communication component(s) 414 may also include one or more components for communicating over a wired network.

The apparatus 400 may be implemented as a control system, or as part of a control system, for the machine 116 of FIG. 1. The apparatus 400 may be part of the machine 116, or the apparatus 400 may be separate from the machine 116. For example, the apparatus 400 may communicate with the machine 116 via the at least one transceiver 408 and/or the at least one other communication component 414. The apparatus 400 may receive observation data, including machine state data 110, environment observation data and constraints from one or more sensors and/or other devices. Machine state data 110 may be received directly from then machine 116, for example. Any suitable method for obtaining such data for use by the apparatus 400 in implementing the diffusion policy may be used.

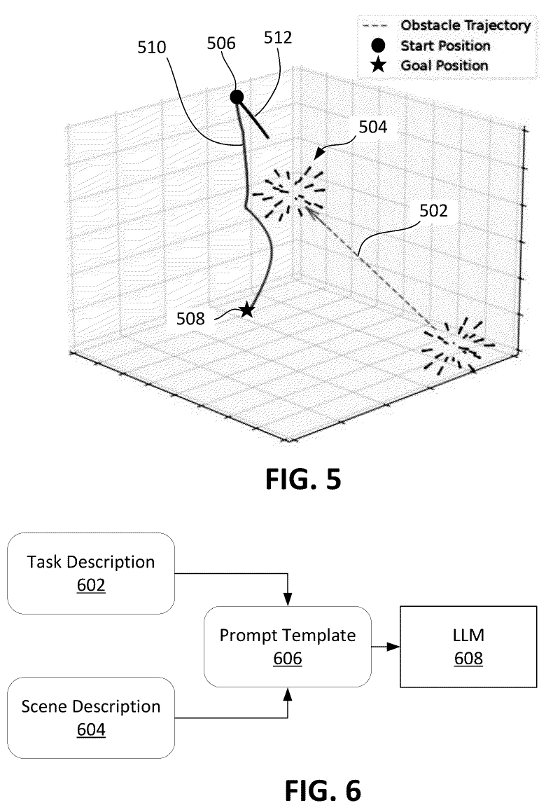

FIG. 5 shows simulation results in a three-dimensional space demonstrating a comparison of dynamic obstacle avoidance between the RUG-DP approach described herein and a prior, baseline Guided-DP approach. FIG. 5 illustrates movement of a simulated obstacle 504 along a path 502, and first and second simulated movement paths 510 and 512 of a robotically controlled end-effector of a robot arm (not shown). The end-effector has a start position 506 and a goal position 508 shown in FIG. 5. The first simulated movement path 510 is generated by the RUG-DP approach described herein, and the second simulated movement path 512 is generated by the Guided-DP approach with a guidance signal added in the denoising phase. In both cases, a predefined rule (constraint) is provided to the diffusion policy, and the predefined rule is a Repulsive Spherical Obstacle Avoidance Function defined as follows:

$$f = {\sum }_{t} sigmoid ( - ( {‖ {C}_{ee}^{t} - {C}_{obs}^{t} ‖}_{2}^{2} - r ) \times 50 ) \times 100$$

where

$${C}_{e e}^{t}$$

is the end-effector's Cartesian Coordinates attime t,

$${C}_{o b s}^{t}$$

and is the obstacle's center coordinates at time t, and r is the radius of the obstacle 504.

As shown, the high-frequency control provide by the RUG-DP approach adapted faster to changes, avoided the obstacle 504 and reached the goal position 508. The Guided-DP approach, with lower control frequency, approached the obstacle 504 too closely, leading to large guidance corrections and trajectory divergence.

Table 2 below shows results of a series of simulated trials performed using the MetaWorld™ benchmark The trials include: 60 static obstacle trials; and 20 dynamic obstacle trials. In the trials, the RUG-DP approach described herein was tested against the prior baseline Guided-DP approach. As shown in the table, the RUG-DP approach significantly outperformed the baseline Guided-DP approach.

TABLE 2

| | |
|---|---|
| Static Obstacle | Dynamic Obstacle |

| Method | Success | Failure | Success | Failure |
|---|---|---|---|---|
| Guided DP | 15 | 85 | 10 | 90 |
| RUG-DP | 63.3 | 36.7 | 45 | 55 |

As discussed above, an LLM (such as the LLM 416 in FIG. 4) may be employed to generate guidance information. A visual perception module (such as the visual perception module 418 in FIG. 4) may also be used to generate guidance information. A visual perception module may perform object segmentation on 3D point cloud observation data. The 3D point cloud data maybe captured by one or more sensors such as RGBD cameras. The LLM and the visual perception module may be implemented by the apparatus 400 of FIG. 4, for example. Given a task and scene description, the LLM and visual perception module may output target and obstacle guidance information. Given guidance information, a guidance signal may be computed for high-frequency closed-loop control using the RUG-DP methods described herein.

FIG. 6 is a block diagram illustrating input to the LLM to generate guidance information. The task description and the scene description (generated by object detection) may be input to an LLM prompt template. A task description 602 and a scene description 604 are input into an LLM prompt template 606, which is input to LLM 608. The prompt template 606 may be designed to direct the LLM to generate guidance information. The LLM 608 then generates guidance information output 610. This guidance information may be provided to the apparatus 400 for generating a guidance signal (gₜ) by the differentiable loss function. The LLM may, for example, be one of the Llama™ family of LLMs from Meta™, or another LLM.

By way of example, a robot arm with an end-effector may be controlled using the RUG-DP approach described herein, and a user may input the prompt “Pick up the banana on the table while avoiding the blue disinfecting wipes canister and the green square jar” as a task description. To form the scene description, the visual perception module may perform object detection using the visual perception module to identify objects in the scene and their positions. For example, objects in the scene may be identified as “banana”, “blue_bottle”, “green_jar”, “book”, etc., each having an associated coordinate position in the environment. A scene description data in the above example could include:

Objects in the Scene

[{object: ′banana′, xy:[400,400]},
a {object: ′blue_bottle’, xy:[350, 350]},
{object: ′green jar′, xy:[240, 400]},
{object: ′book′, xy:[450,450]}]

The LLM prompt template may include a variety of fields including (but not limited to), “#Role”; “#Example”; “#Instruction”; “##Task Description”; “##Scene Description”. By way of example only, the #Role field in the template may be populated to specify that the LLM is a robotic manipulation task guide, and the #Instruction field may be populated to specify “Given the task and scene description, output the task guidance” or something similar. The ##Task Description and ##Scene Description fields may be populated with the task and scene descriptions discussed above, for example.

This guidance information may be provided to the differentiable loss function 112 for generating a guidance signal (gt) by the differentiable loss function.

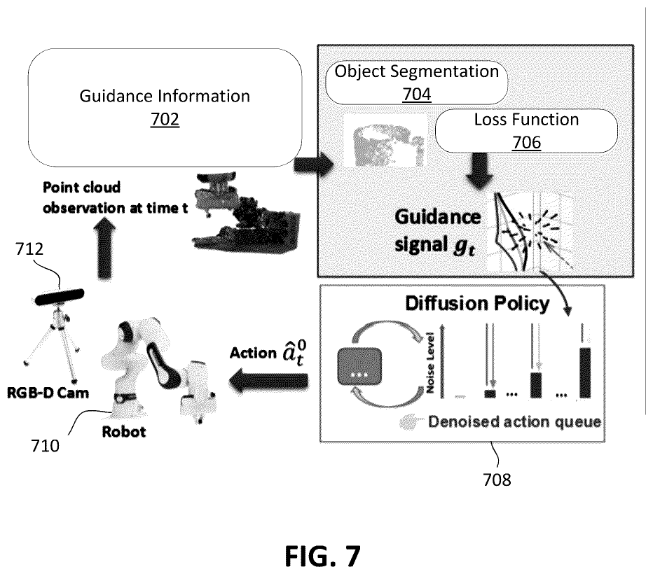

FIG. 7 is a diagram illustrating closed-loop feedback control of a robot according to some embodiments. Guidance information 702 generated by the LLM 608 in FIG. 6, including object segmentation data 704, is input to the differentiable loss function 706 (which may be the loss function 112 of FIGS. 1 and 2), which generates the guidance signal (gₜ). The guidance signal (gₜ) is input to the diffusion policy 708 (which may be the RUG-DP 114 of FIGS. 1 and 2) at inference time and applied to the action queue. At each inference time, after performing a denoising step, the diffusion policy 708 outputs a denoised action

$$( {\hat{a}}_{t}^{0} ) .$$

The denoised action

$$( {\hat{a}}_{t}^{0} )$$

controls a robot 710 in this example, and updated environment observation data (captured by RGB-D camera 712) in the form of a point cloud observation at time t is processed for object segmentation and feedback to the loss function 706. The closed-loop process repeats (over and over) to iteratively generate a sequence of denoised actions and, thereby, control the robot 710.

Aspects and embodiments of the disclosure may provide real-time, learning-based motion control apparatuses, possibly enabling seamless, interactive engagement with humans and objects in daily environments. The integration of training-free universal guidance may allow the control apparatus to adapt and perform wide range of tasks in any static or dynamic environments without additional training, saving on training costs otherwise needed for environment-based adaptability.

A neural network is a computational system comprising computational units (sometimes referred to as neurons) that are arranged in layers (or computational blocks). A neural network may include a first neural network layer (which may be referred to as an input layer), at least one intermediate neural network layer (which may be referred to as intermediate layer(s)) and a final neural network layer (which may be referred to as an output layer). Each neural network layer may receive input data (e.g., in the form of an input vector) and performs computations, including applying some weights (e.g., in the form of a weight vector) to the input data to generate output data (e.g., in the form of an output vector). If a neural network has multiple intermediate layers, the output generated by one intermediate layer (which may be referred to as intermediate data) may be used as the input data to a subsequent intermediate layer. The output of a multi-layer neural network may be the output generated by the final layer.

When a neural network is executed (e.g., during training or inference), the output of each neural network layer may be computed in sequence. Often, computing a neural network layer involves computing an inner product between the input data and the weights of the neural network layer. With increasing neural network complexity (e.g., increasing number of layers), there is an increase in computation cost and memory cost.

Large Language Models (LLMs) are computational models used for language generation and other natural language processing, such as text classification. LLMs are neural network models that learn the semantics and syntax of language by encoding words or subwords into vector representations. These models are trained on extensive datasets and are widely used in various artificial intelligence (AI) applications, including text generation, sentiment analysis, and generic question-answering (QA) systems. LLMs enable these systems to understand and generate responses to a broad range of queries, making them integral to applications like virtual assistants and chatbots. Examples of LLMs include ChatGPT (a generative artificial intelligence chatbot developed by OpenAI of San Francisco, California, USA), GPT-4 (Generative Pre-trained Transformer 4, which is a multimodal large language model created by OpenAI of San Francisco, California, USA), LLaMA (a family of autoregressive large language models released by Meta AI of Astor Place, New York City, New York, USA), and PaLM2 (a transformer-based large language model developed by Google AI of Mountain View, California, USA), which have proven to achieve state-of-the-art (SOTA) performance in various natural language processing (NLP) tasks.

Herein, the term “predefined” (for example, a “predefined” item such as a “predefined” parameter) refers to an item defined before the method disclosed herein is performed (for example, defined as a system design parameter such as defined by relevant standards).

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

Herein, various embodiments are described. In various embodiments, the methods disclosed herein may be implemented as hardware, software, firmware, or a combination thereof, and may be implemented in any suitable form.

For example, in some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

What is claimed is:

1. A method for guided diffusion policy-based machine control, the method comprising:
initializing an action queue, the action queue comprising a sequence of H actions for controlling a machine, wherein H is an integer, the sequence of actions having monotonically increasing noise; and
repeating a set of steps to iteratively generate a sequence of denoised machine control actions using a diffusion model having H sampling steps, the set of steps comprising, for each iteration:
performing a respective denoising step on the action queue using the diffusion model, thereby generating a respective denoised machine control action at a front of the action queue;
outputting the respective denoised machine control action for controlling the machine;
generating a respective guidance signal as a function of guidance data; and
applying the respective guidance signal to the action queue; and
updating the action queue, comprising removing the respective denoised machine control action from the front of the action queue.

2. The method of claim 1, wherein updating the action queue further comprises appending a new noisy machine control action to an end of the action queue.

3. The method of claim 1, wherein performing the denoising step comprises performing a single diffusion sampling step on the action queue by the diffusion model.

4. The method of claim 1, wherein performing the denoising step comprises performing the denoising step as a function of machine state data.

5. The method of claim 4, further comprising, after outputting the respective denoised machine control action, obtaining updated machine state data.

6. The method of claim 1, wherein the guidance data comprises one or both of environment observation data and constraint data.

7. The method of claim 6, further comprising, after outputting the respective denoised machine control action, obtaining updated environment observation data.

8. The method of claim 1, wherein the guidance signal is a training free guidance signal.

9. The method of claim 1, wherein the guidance signal is generated using a differentiable loss function method.

10. The method of claim 1, wherein the machine comprises a robot.

11. An apparatus comprising:
at least one processor; and
one or more non-transitory computer-readable storage media functionally coupled to the at least one processor;
wherein the one or more non-transitory computer-readable storage media comprise computer-executable instructions, wherein the instructions, when executed, cause the at least one processor to perform a method for guided diffusion policy-based machine control, the method comprising:
initializing an action queue, the action queue comprising a sequence of H actions for controlling a machine, wherein H is an integer, the sequence of actions having monotonically increasing noise; and
repeating a set of steps to iteratively generate a sequence of denoised machine control actions using a diffusion model having H sampling steps, the set of steps comprising, for each iteration:
performing a respective denoising step on the action queue using the diffusion model, thereby generating a respective denoised machine control action at a front of the action queue;
outputting the respective denoised machine control action for controlling the machine;
generating a respective guidance signal as a function of guidance data; and
applying the respective guidance signal to the action queue; and
updating the action queue, comprising removing the respective denoised machine control action from the front of the action queue.

12. The apparatus of claim 11, wherein updating the action queue further comprises appending a new noisy machine control action to an end of the action queue.

13. The apparatus of claim 11, wherein performing the denoising step comprises performing a single diffusion sampling step on the action queue by the diffusion model.

14. The apparatus of claim 11, wherein performing the denoising step comprises performing the denoising step as a function of machine state data.

15. The apparatus of claim 14, wherein the method further comprises, after outputting the respective denoised machine control action, obtaining updated machine state data.

16. The apparatus of claim 11, wherein the guidance data comprises one or both of environment observation data and constraint data.

17. The apparatus of claim 16, wherein the method further comprises, after outputting the respective denoised machine control action, obtaining updated environment observation data.

18. The apparatus of claim 11, wherein the guidance signal is a training free guidance signal.

19. The apparatus of claim 11, wherein the guidance signal is generated using a differentiable loss function method.

20. One or more non-transitory computer-readable storage media comprising computer-executable instructions, wherein the instructions, when executed, cause at least one processor to perform the method of claim 1.
